(19) United States
(12) Patent Application Publication
(10) Pub. No.: US 2008/0299480 A1
(43) Pub. Date: Dec. 4, 2008

(54) Liquid Developer Process for Producing Liquid Developer, and Image Forming Apparatus

(75) Inventor: Koji Akioka, North Adelaide (AU)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/056,057

(22) Filed: Mar. 26, 2008

(30) Foreign Application Priority Data
May 31, 2007 (JP) 2007-146282

(51) Int. Cl. G03G 9/12; G03G 15/16

(52) U.S. Cl. 430/113; 430/137.22; 399/307

(57) ABSTRACT

A liquid developer includes toner particles containing mainly a resin material, and a nonvolatile insulating liquid, the toner particles containing therein a liquid constituting the insulating liquid.

### BACKGROUND

1. Technical Field

The present invention relates to a liquid developer, a process for producing a liquid developer, and an image forming apparatus.

2. Related Art

A developer for developing an electrostatic latent image formed on a latent image carrying member includes a dry toner used in a dry state constituted by a material containing a colorant/such as a pigment, and a binder resin, and a liquid developer (liquid toner) constituted by a toner dispersed in an electrically insulating carrier liquid (insulating liquid), as disclosed in JP-A-2006-251253.

A method using a dry toner is advantageous owing to the use of a toner in a solid state, but has a concern of adverse influence of powder to a human body and has a problem in contamination due to scattering of the toner and unevenness upon dispersing the toner. A dry toner is liable to suffer aggregation, and the size of the toner particles is difficult to reduce, whereby a toner image having high resolution is difficult to form. In the case where the size of the toner particles is relatively small, the aforementioned problems due to the powder form of the toner significantly arise.

In a method using a liquid developer, on the other hand, the toner particles in the liquid developer are effectively prevented from being aggregated, whereby fine toner particles can be used, and a binder resin having a low softening point (low softening temperature) can be used. Accordingly, the method using a liquid developer is advantageous in reproducibility of a thin line image, favorable in gradation reproducibility, and excellent in color reproducibility, and is suitable for a high-speed image forming method.

However, a liquid developer having been used is improved in dispersibility of the toner particles and in storage stability as compared to a dry toner, but it is difficult to maintain the favorable dispersion state for a prolonged period of time due to low affinity between the insulating liquid and the toner particles. As a result, it is difficult to sufficiently secure storage stability and long-term stability of the liquid developer.

### SUMMARY

An advantage of some aspects of the invention is to provide such a liquid developer that is excellent in storage stability and long-term stability, and a method for producing the liquid developer. Another advantage of some aspects of the invention is to provide an image forming apparatus using the above-described liquid developer.

According to an aspect of the invention, a liquid developer is provided that contains toner particles containing mainly a resin material, and a nonvolatile insulating liquid. The toner particles contain therein a liquid constituting the insulating liquid.

It is preferred in the liquid developer according to the aspect of the invention that the toner particles and the insulating liquid contain a fatty acid triglyceride.

It is preferred in the liquid developer according to the aspect of the invention that the toner particles and the insulating liquid contain an ester liquid having an aniline point of 30° C. or less.

It is preferred in the liquid developer according to the aspect of the invention that the toner particles and the insulating liquid contain a fatty acid monoester.

It is preferred in the liquid developer according to the aspect of the invention that the resin material has an ester and/or a carboxylic acid as a functional group.

It is preferred in the liquid developer according to the aspect of the invention that the resin material has a crystalline structure and/or a crosslinked structure.

According to another aspect of the invention, a process for producing a liquid developer is provided. The method contains steps of: preparing a swollen resin liquid containing a resin material swollen with an insulating liquid, by heating a composition containing the resin material and the insulating liquid; and depositing the resin to form resin fine particles containing mainly the resin material and containing therein the insulating liquid, by cooling the swollen resin liquid.

It is preferred in the process for producing a liquid developer according to the aspect of the invention that the swollen resin liquid is prepared by heating the composition at a temperature higher than a melting point of the resin material contained in the composition.

According to still another aspect of the invention, an image forming apparatus is provided that contains: plural developing units that provide plural monochrome images having different colors by using plural liquid developers having the different colors; an intermediate transferring unit that forms an intermediate transferred image containing the plural monochrome images formed in the developing units, the plural monochrome images being sequentially transferred and overlapped to form the intermediate transferred image; a secondary transferring unit that transfers the intermediate transferred image to a recording medium to form an unfixed color image on the recording medium; and a fixing unit that fixes the unfixed color image to the recording medium. The liquid developers each contain toner particles containing mainly a resin material, and an insulating liquid. The toner particles contain therein a liquid constituting the insulating liquid.

According to the aspects of the invention, a liquid developer that is excellent in storage stability and long-term stability, a process for producing liquid developer that is capable of producing the liquid developer efficiently, and an image forming apparatus using the liquid developer are provided.

### BRIEF DESCRIPTION OF THE DRAWINGS

The invention will be described with reference to the accompanying drawings, wherein like numbers reference like elements.

FIG. 1 is a schematic illustration showing an example of an image forming apparatus, to which a liquid developer according to an aspect of the invention is applied.

FIG. 2 is an enlarged view showing a part of the image forming apparatus shown in FIG. 1.

FIG. 3 is a schematic illustration showing an example of a state of toner particles in a liquid developer layer, on a developing roller.

FIG. 4 is a cross sectional view showing an example of a fixing device applied to the image forming apparatus shown in FIG. 1.

### DESCRIPTION OF EXEMPLARY EMBODIMENTS

Embodiments of the invention will be described in detail with reference to exemplary embodiments.

### Liquid Developer

The liquid developer according to an embodiment of the invention contains an insulating liquid having dispersed therein toner particles.

### Toner Particles

The toner particles will be described.

### Constitutional Components of Toner Particles (Toner Materials)

The toner particles (toner) constituting the liquid developer of the embodiment of the invention contain at least a resin material and a liquid (liquid component) constituting an insulating liquid described later.

In the liquid developer having the toner particles containing therein a liquid constituting the insulating liquid, the affinity between the toner particles and the insulating liquid is improved, whereby excellent dispersibility of the toner particles in the insulating liquid can be obtained. According to the constitution, the toner particles can be prevented from suffering aggregation in the liquid developer to improve liquid developer in storage stability. The toner particles in the liquid developer are favorably dispersed in the insulating liquid without aggregation. The liquid developer maintains the charging characteristics and a constant viscosity thereof for a prolonged period of time, thereby being improved in long-term stability. An image obtained by applying the liquid developer to an image forming apparatus described later is excellent in gradation reproducibility and color reproducibility. It may be considered that a dispersant is added to the insulating liquid to adsorb the dispersant onto the surface of the toner particles for improving the dispersibility of the toner particles in the insulating liquid. In this method, however, it is necessary to increase the amount of the dispersant added to the insulating liquid for improving the dispersibility of the toner particles, and thus the toner image obtained contains a large amount of the dispersant, whereby it is difficult to exhibit the color tone inherent to the toner particles. The dispersant adsorbed on the surface of the toner particles is liable to be released therefrom, and thus it is difficult to maintain high dispersibility of the toner particles in the liquid developer for a prolonged period of time. In the liquid developer of the embodiment of the invention, on the other hand, the toner particles contain therein a liquid constituting the insulating liquid, whereby the dispersibility of the toner particles in the insulating liquid is improved. The insulating liquid contained in the toner particles is not only dispersed at the surface part of the toner particles but also dispersed uniformly over the entire toner particles. Accordingly, the high affinity between the toner particles and the insulating liquid is maintained for a prolonged period of time, and the dispersibility of the toner particles in the insulating liquid is improved for a prolonged period of time. In the liquid developer of the embodiment of the invention, upon adding a dispersant for further improving the dispersibility of the toner particles, the advantage of the dispersant can be sufficiently obtained in the case where the addition amount of the dispersant is decreased. In the case where the insulating liquid described later is a mixture of plural kinds of liquids, the advantages can be obtained in the case where the toner particles contain therein at least one kind of liquid among the plural kinds of liquids constituting the insulating liquid.

In the case of a liquid developer containing toner particles that do not contain a liquid constituting an insulating liquid, on the other hand, the aforementioned excellent storage stability and long-term stability cannot be obtained. Specifically, the affinity between the toner particles and the insulating liquid is deteriorated, whereby it is difficult to disperse the toner particles uniformly in the insulating liquid. In the liquid developer, the toner particles are liable to be aggregated to fail to provide sufficient storage stability. The liquid developer contains simultaneously the toner particles having been aggregated and the toner particles not aggregated. The liquid developer containing the toner particles exhibits unstable charging characteristics and is increased in viscosity, whereby it is difficult to attain stable image formation. Even in the case where such a liquid developer is used that contains toner particles and an insulating liquid exhibiting relatively high affinity between the resin material constituting the toner particles and the insulating liquid, the toner particles are aggregated as a result of long-term storage, whereby the liquid developer cannot attain sufficient storage stability and long-term stability.

The components constituting the toner particles will be described in detail below.

### 1. Resin Material

The toner constituting the liquid developer is constituted by a material containing a resin material (which may be hereinafter simply referred to as a resin) as a major component.

In the embodiment of the invention, the resin (resin material) is not particularly limited, and for example, known resins may be used.

The resin material preferably has a crystalline structure and/or a crosslinked structure. The resin material having the structure is swollen by containing an insulating liquid described later, and consequently, can certainly retain the insulating liquid inside the toner particles. According to the constitution, the affinity between the toner particles and the insulating liquid is further improved to provide particularly improved dispersibility of the toner particles in the insulating liquid, whereby the liquid developer is particularly improved in storage stability and long-term stability. The toner particles containing the resin material as the constitutional component is excellent in durability (heat resistance and solvent resistance). Accordingly, upon storing the liquid developer, the toner particles can be certainly prevented from suffering fusion and aggregation of each other during long period, irrespective of the temperature for storing and the kind of the insulating liquid used.

In the case where the insulating liquid described later contains at least one of a fatty acid triglyceride, fatty acid monoester and a synthetic ester liquid having characteristics described later (which may be hereinafter referred to as an ester liquid as a generic term), the resin material preferably has an ester and/or a carboxylic acid as a functional group. In the liquid developer satisfying the aforementioned conditions, the insulating liquid (ester liquid) can be certainly contained inside the toner particles owing to the similarity in chemical structure between the resin material constituting the toner particles and the ester liquid. According to the constitution, the affinity between the toner particles and the insulating liquid containing the ester liquid is further improved, whereby the liquid developer is particularly improved in storage stability and long-term stability. The ester liquid has an effect of plasticizing the resin material of the toner particles (i.e., plasticizing effect). In the toner particles containing the above-described ester liquid, the resin material is effectively plasticized with the ester liquid by heating upon fixing, and the toner particles are easily melted at a relatively low temperature and thus fixed to a recording medium. The toner particles thus plasticized can be fixed further firmly to the recording medium, and a toner image obtained is particularly improved in fixing strength. In the case where paper is used as the recording medium, for example, the toner particles are liable to penetrate into fibers of the paper. A part of the toner particles (i.e., the resin material constituting the toner particles) melted by heating upon fixing penetrates into the interior of the recording medium, and then by hardening the toner particles by standing to cool in this state, anchoring effect is exhibited to improve the fixing characteristics between the paper and the toner particles. Therefore, a liquid developer containing the toner particles is excellent in low temperature fixing property and is further excellent in fixing strength of the toner particles to the recording medium.

Examples of the resin material containing an ester and/or a carboxylic acid as a functional group include an ethylene copolymer, such as an ethylene-acrylic acid copolymer, an ethylene-methacrylic acid copolymer, an ethylene-vinyl acetate copolymer, a partially saponified product of an ethylene-vinyl acetate copolymer, an ethylene-acrylate ester copolymer and an ethylene-methacrylate ester copolymer, a polyester resin, a styrene-acrylate ester copolymer and a styrene-methacrylate ester copolymer.

Among these, in the case where the resin material contains the ethylene copolymer, the following advantages can be obtained. The toner particles containing the ethylene copolymer can be certainly suppressed from suffering deformation and aggregation of the toner particles even upon storing the liquid developer under a relatively high temperature atmosphere. Accordingly, upon storing a liquid developer containing the toner particles in an image forming apparatus, the toner particles can be certainly prevented from suffering fusion and aggregation of each other inside the apparatus that is heated by operation, whereby the liquid developer is particularly improved in storage stability and long-term stability. The ethylene copolymer has particularly high affinity with the ester liquid. Accordingly, the toner particles containing the ethylene copolymer certainly contain the ester liquid inside, and upon fixing, the toner particles can be fixed firmly to a recording medium at a low temperature. In the case where the toner particles contain an ethylene-(methacrylic acid copolymer among the ethylene copolymers as the resin material constituting the toner particles, the aforementioned advantages can be obtained particularly significantly.

In the case using a polyester resin among the resin materials, the resulting image has high coloring property owing to the high transparency of the polyester resin.

The melting point Tm (° C.) of the resin (resin material) is not particularly limited, and is preferably from 80 to 140° C., more preferably from 85 to 120° C., and further preferably from 85 to 115° C. According to the constitution, the toner particles can be certainly fixed to a recording medium upon fixing. Furthermore, even in the case where the fixing temperature upon fixing is relatively low, the toner particles can be favorably fixed to a recording medium. Moreover, the toner particles can be certainly prevented from suffering unintended deformation and aggregated upon storing. In the embodiment of the invention, the melting point may be measured, for example, according to JIS K7121 1987.

The Vicat softening temperature Tv (° C.) of the resin material is not particularly limited, and is preferably from 40 to 100° C., more preferably from 45 to 95° C., and further preferably from 50 to 90° C. According to the constitution, the toner particles can be certainly prevented from suffering aggregation and deformation thereof upon storing. In the embodiment of the invention, the Vicat softening point may be measured, for example, according to JIS K7206 1999.

### 2. Liquid Component

As having been described above, the toner particles contain a liquid (liquid component) constituting the insulating liquid described later. In the case where the insulating liquid is constituted by only one kind of a liquid, the liquid constituting the insulating liquid referred herein is the liquid itself, and in the case where the insulating liquid is constituted by plural kinds of liquids, the liquid constituting the insulating liquid referred herein may be a part of the kinds of liquids or maybe the entire kinds of liquids. In the case where the toner particles contain the liquid constituting the insulating liquid described later, the toner particles are improved in dispersibility in the insulating liquid to improve the liquid developer in storage stability and long-term stability.

The liquid component is not limited as far as it is a liquid constituting the insulating liquid described later, and for example, liquids that have been known as an insulating liquid may be used. Specific examples thereof include a silicone oil, such as KF96, KF4701, KF96S, KS602A, KS603, KS604, KF41, KF54 and FA630 (produced by Shin-Etsu Silicone Co., Ltd.), TSF410, TSF433, TSF434, TSF451 and TSF437 (produced by Momentive Performance Materials Japan LLC.) and SH200 (produced by Toray Industries, Inc.), an aliphatic hydrocarbon, such as Isopar E, Isopar G, Isopar H and Isopar L (produced by Exxon Mobil Corp.), Cosmowhite P-60, Cosmowhite P-70 and Cosmowhite P-120 (produced by Cosmo Oil Lubricants Co., Ltd.), Diana Fresia W-8, Daphne Oil CP, Daphne Oil KP, Transformer Oil H, Transformer Oil G, Transformer Oil A, Transformer Oil B and Transformer Oil S (produced by Idemitsu Kosan Co., Ltd.), Shellsol 70 and Shellsol 71 (produced by Shell Oil Company), Amsco OMS and Amsco 460 (produced by American Mineral Spirits Co.), low-viscosity and high-viscosity liquid paraffin (produced by Wako Pure Chemical Industries, Ltd.), octane, isooctane, decane, isodecane, decalin, nonane, dodecane, isododecane, cyclohexane, cyclooctane and cyclodecane, a fatty acid triglyceride, a fatty acid monoglyceride, a fatty acid diglyceride, a decomposed product of a fatty acid triglyceride, such as glycerin and a fatty acid, a synthetic ester liquid, such as Prifer 6813 (produced by UNIQEMA), benzene, toluene, xylene, mesitylene and a fatty acid monoester, which may be used solely or in combination of plural kinds of them.

Among these, in the case where the liquid component contained in the toner particle contains a fatty acid triglyceride, the following advantages can be obtained. The fatty acid triglyceride contained in the toner particles exhibit the plasticizing effect of plasticizing the resin material of the toner particles, and the plasticizing effect is exhibited significantly upon fixing. Accordingly, the toner particles can be fixed to a recording medium at a relatively low temperature, and the fixing strength of the toner particles to the recording medium is improved. In the case where the toner particles contain a fatty acid triglyceride, and the insulating liquid contains a fatty acid triglyceride, the toner particles are particularly improved in dispersibility in the liquid developer. Furthermore, even upon storing the liquid developer at a relatively high temperature for a prolonged period of time, the toner particles can be prevented from suffering fusion and aggregation of each other. Accordingly, in the case where the toner particles contain a fatty acid triglyceride, and the insulating liquid contains a fatty acid triglyceride, the liquid developer can be particularly improved in all storage stability, long-term stability and low temperature fixing property. Furthermore, since the fatty acid triglyceride is an environmentally benign component, and thus the load on the environment-caused by leakage of the liquid developer outside an image forming apparatus and disposal of a used liquid developer can be reduced. As a result, an environmentally benign liquid developer can be provided.

The fatty acid triglyceride referred herein is a triester of glycerin and a fatty acid (triglyceride). The fatty acid component contained in the fatty acid triglyceride is not particularly limited, and examples thereof include a saturated fatty acid, such as butyric acid, caproic acid, caprylic acid, capric acid, lauric acid, myristic acid, palmitic acid, stearic acid, arachic acid, behenic acid and lignoceric acid, a monobasic unsaturated fatty acid, such as crotonic acid, myristoleic acid, palmitoleic acid, oleic acid, elaidic acid, vaccenic acid, gadoleic acid, erucic acid and nervonic acid, a polybasic unsaturated fatty acid, such as linoleic acid, α-linolenic acid, γ-linolenic acid, arachidonic acid, eleostearic acid, stearidonic acid, arachidonic acid, clupanodonic acid, docosahexaenoic acid (DHA) and eicosapentaenoic acid (EPA), and derivatives thereof, which may be used solely or in combination of plural kinds of them.

Among these, in the case where fatty acid triglyceride contains a saturated fatty acid as the fatty acid component, the fatty acid triglyceride is difficult to suffer deterioration (such as oxidation and decomposition), i.e., chemically stable. Accordingly, the toner particles containing the fatty acid triglyceride are certainly prevented from suffering deterioration phenomenon, such as discoloration, upon storing for a prolonged period of time, and as a result, image formation with stable quality can be carried out over a prolonged period of time. Furthermore, the fatty acid triglyceride is still present in the toner particles after fixing, and since the fatty acid triglyceride containing a saturated fatty acid component is chemically stable, the fixed toner image is certainly prevented from suffering discoloration upon exposing to an external environment (such as light, heat and oxygen), whereby the toner image formed can maintain the sharpness thereof for a prolonged period of time.

Among the saturated fatty acids, a saturated fatty acid having from 6 to 22 carbon atoms in the molecule of the saturated fatty acid component is preferred, a saturated fatty acid having from 8 to 20 carbon atoms is more preferred, and a saturated fatty acid having from 10 to 18 is further preferred. The aforementioned advantages can be exhibited further significantly in the case where the saturated fatty acid component is contained.

In the case where the fatty acid triglyceride contains an unsaturated fatty acid component as the fatty acid component, the fatty acid triglyceride can contribute to improvement in long-term storage stability of the toner image obtained through image formation. It is considered that this is because of the following mechanisms. The unsaturated fatty acid component is cured by itself upon oxidation thereof. In the case where a toner image is formed and fixed on a recording medium, the fatty acid triglyceride remaining as a component constituting the toner image along with the toner particles can undergo oxidation polymerization with oxygen or the like in the air, whereby the toner particles can be firmly adhered to each other, and the toner particles and the recording medium can be firmly adhered to each other.

The unsaturated fatty acid triglyceride can be obtained efficiently from a naturally-derived oil as an oil derived from vegetables, such as sunflower oil, safflower oil, rice oil, rice bran oil, rapeseed oil, olive oil, sesame oil, canola oil, soybean oil, linseed oil and caster oil, and an oil derived from animals, such as beef tallow oil.

In the case where the liquid component contained in the toner particles contains an ester liquid having an aniline point of 30° C. or less, the following advantages can be obtained. An aniline point is generally used as an index of dissolution power of an organic solvent to a resin or the like, and in general, an organic solvent having a lower aniline point has higher dissolving power to a resin or the like. The aniline point of the ester liquid can be obtained as the minimum temperature where the same volume of aniline and the ester liquid are present as a uniform solution. Specifically, the aniline point is obtained in the following manner. A mixture of aniline and the liquid is heated under stirring to provide a completely mixed transparent state. The temperature of the mixture is then decreased, and the temperature, at which the mixture starts to be turbid, is designated as the aniline point. The aniline point referred herein is a value that is measured and obtained according to JIS K2256.

The ester liquid having an aniline point of 30° C. or less significantly exhibits the plasticizing effect of plasticizing the resin material contained in the toner particles, and upon heating the resin material, the ester liquid easily softens and melts the resin material. Accordingly, the toner particles can be fixed to a recording medium further firmly at a low temperature, whereby the liquid developer is particularly improved in low temperature fixing property. Moreover, a toner image formed with the liquid developer is particularly improved in fixing strength.

Examples of the ester liquid that satisfies the aforementioned conditions include a fatty acid monoester.

In the case where the liquid component contained in the toner particles contains the fatty acid monoester, the following advantages can be obtained in addition to the aforementioned advantages. A fatty acid monoester is an ester of a fatty acid and a monohydric alcohol. Therefore, a fatty acid monoester is an environmentally benign component. Accordingly, load on the environments caused by leakage of the liquid developer outside an image forming apparatus and disposal of a used liquid developer can be reduced. As a result, an environmentally benign liquid developer can be provided.

The fatty acid component constituting the fatty acid monoester is not particularly limited, and examples thereof include an unsaturated fatty acid, such as oleic acid, palmitoleic acid, linoleic acid, α-linolenic acid, γ-linolenic acid, arachidonic acid, docosahexaenoic acid (DHA) and eicosapentaenoic acid (EPA), and a saturated fatty acid, such as butyric acid, lauric acid, caproic acid, caprylic acid, capric acid, myristic acid, palmitic acid, stearic acid, arachidinic acid, behenic acid and lignoceric acid, which may be used solely or in combination of plural kinds of them.

Among these, in the case where the fatty acid monoester contains a saturated fatty acid as the fatty acid component, the fatty acid monoester is difficult to suffer deterioration (such as oxidation and decomposition), i.e., chemically stable. Accordingly, the toner particles containing the fatty acid monoester are certainly prevented from suffering deterioration phenomenon, such as discoloration and degeneration, for a prolonged period of time, and thus the liquid developer is particularly excellent in long-term stability and storage stability. Upon fixing, a toner image formed contains the fatty acid monoester. As having been described, the fatty acid monoester containing a saturated fatty acid as a constitutional component is difficult to suffer deterioration, and therefore, even in the case where the toner image is exposed to an external atmosphere (such as light, heat and oxygen), the toner image is certainly prevented from suffering discoloration and can maintain the sharpness thereof for a prolonged period of time.

In the case where the fatty acid monoester contains a saturated fatty acid as the fatty acid component, a fatty acid having from 8 to 22 carbon atoms is preferably contained as the saturated fatty acid. According to the constitution, the fatty acid monoester exerts the plasticizing effect particularly effectively, and thus the liquid developer is particularly improved in fixing characteristics. Furthermore, the toner particles can be certainly prevented from suffering aggregation and deformation thereof upon storing.

In the case where the fatty acid monoester contains an unsaturated fatty acid component as the fatty acid component, the fatty acid monoester can contribute to improvement in long-term storage stability of the toner image obtained through image formation. It is considered that this is because of the following mechanisms. The unsaturated fatty acid component is cured by itself upon oxidation thereof. Accordingly, in the case where a toner image is formed and fixed on a recording medium, the fatty acid monoester remaining in the toner image along with the toner particles can undergo oxidation polymerization with oxygen or the like in the air, whereby the toner particles can be firmly adhered to each other, and the toner particles and the recording medium can be firmly adhered to each other. The unsaturated fatty acid component of the fatty acid monoester can undergo oxidation polymerization while covering the surface of the toner image, and therefore, a protective film of the cured fatty acid monoester can be formed on the surface of the toner image. Because of the aforementioned factors, the toner image can be prevented from suffering deterioration due to external physical force, such as friction, the air, light and the like to have excellent long-term stability.

The fatty acid monoester is an ester of a fatty acid and a monohydric alcohol, and the alcohol is preferably an alkyl alcohol having from 1 to 4 carbon atoms. According to the constitution, the fatty acid monoester can be certainly retained in the toner particles, and the aforementioned plasticizing effect can be certainly exhibited upon fixing. Accordingly, the toner particles can be firmly fixed to a recording medium. Furthermore, the liquid developer is improved in chemical stability, and thus the liquid developer is further improved in storage stability and long-term stability. Examples of the alcohol include methanol, ethanol, propanol, butanol and isobutanol.

In the case where the liquid component contained in the toner particles contains a synthetic ester liquid having an aniline point of 30° C. or less, the following advantages can be obtained in addition to the aforementioned advantages. The synthetic ester liquid is chemically stable and stabilizes the characteristics of the liquid developer for a prolonged period of time. In the case where the synthetic ester liquid is used in the liquid developer, it is not released from the liquid developer as VOC (volatile organic compound) upon storing and forming an image, and the liquid developer particularly becomes harmless to the human body and the environment.

The aniline point of the synthetic ester liquid is 30° C. or less, preferably 15° C. or less, and more preferably 10° C. or less. According to the constitution, the effect of plasticizing the resin material by the above-described synthetic ester liquid is significantly exhibited, and thus the liquid developer is particularly improved in low temperature fixing property.

### 3. Colorant

The toner particles may contain a colorant. The colorant is not particularly limited, and for example, a pigment, a dye and the like having been known may be used.

### 4. Other Components

The toner particles may contain other components than those described above. Examples of the components include wax and magnetic powder having been known.

As the constitutional materials (components) constituting the toner particles, other materials than those described above, for example, zinc stearate, zinc oxide, cerium oxide/silica, titanium oxide, iron oxide, a fatty acid, a fatty acid metallic salt and the like may be used.

### Particle Diameter, etc. of Toner Particles

The toner particles constituted by the aforementioned materials preferably have an average particle diameter of from 0.7 to 3 μm, more preferably from 0.8 to 2.5 μm, and further preferably from 0.8 to 2 μm. In the case where the average particle diameter of the toner particles is in the range, the toner particles can be reduced in fluctuation in properties among the particles, whereby a resolution of a toner image formed with the liquid developer can be sufficiently increased while maintaining the total high reliability of the liquid developer. Furthermore, the toner particles can be improved in dispersibility in the insulating liquid to improve the storage stability of the liquid developer. The average particle diameter referred herein means an average particle diameter by volume unless otherwise indicated.

The content of the toner particles in the liquid developer is preferably from 10 to 60% by weight, and more preferably from 20 to 50% by weight.

### Insulating Liquid

The insulating liquid will be described.

The insulating liquid constituting the liquid developer of the embodiment of the invention is a nonvolatile liquid. According to the constitution, the insulating liquid can be certainly prevented from being evaporated upon fixing, and thus a volatile organic compound (VOC) can be certainly prevented from being generated. As a result, the liquid developer particularly becomes harmless to the human body and the organisms. Furthermore, an environmentally benign liquid developer can be provided. The nonvolatile liquid referred herein specifically means a liquid having an initial boiling point measured according to JIS K2254 of 105° C. or more, and more preferably 140° C. or more.

As the insulating liquid, an insulating liquid having been known may be used, and for example, the liquids described for the liquid component contained in the toner particles may be used.

In the case where the insulating liquid contains a fatty acid triglyceride among the known liquids for the insulating liquid, the following advantages can be obtained. A fatty acid triglyceride has high affinity with the resin material constituting the toner particles. Accordingly, in the case where the insulating liquid contains a fatty acid triglyceride, the toner particles can be further improved in dispersibility in the liquid developer. In the case where the insulating liquid contains a fatty acid triglyceride, and the toner particles contain a fatty acid triglyceride as the liquid component, in particular, the toner particles are further improved in dispersibility in the insulating liquid. According to the constitution, the toner particles can be firmly fixed to a recording medium at a low temperature owing to the plasticizing effect to the toner particles by the fatty acid triglyceride, and the liquid developer can be particularly improved in storage stability and long-term stability.

The fatty acid triglyceride is an environmentally benign component, and thus the load of the insulating liquid on environment due to leakage of the insulating liquid outside an image forming apparatus and disposal of the used liquid developer can be reduced. As a result, an environmentally benign liquid developer can be provided.

The fatty acid component contained in the fatty acid triglyceride is not particularly limited, and for example, the saturated fatty acids, the unsaturated fatty acids and the derivatives thereof, which have been described above, may be used.

Among these, in the case where fatty acid triglyceride contains a saturated fatty acid component, the chemical stability of the liquid developer and the electric insulating property of the insulating liquid can be maintained at high levels. According to the constitution, the liquid developer can be further improved in storage stability and long-term stability. Among the saturated fatty acids, a saturated fatty acid having from 6 to 22 carbon atoms in the molecule of the saturated fatty acid component is preferred, a saturated fatty acid having from 8 to 20 carbon atoms is more preferred, and a saturated fatty acid having from 10 to 18 is further preferred. The aforementioned advantages can be exhibited further significantly in the case where the saturated fatty acid component is contained.

In the case where the fatty acid triglyceride contains an unsaturated fatty acid component, the fatty acid triglyceride can contribute to improvement in long-term storage stability of the toner image obtained through image formation. It is considered that this is because of the following mechanisms. The unsaturated fatty acid component is cured by itself upon oxidation thereof. Accordingly, in the case where a liquid developer containing a fatty acid triglyceride containing an unsaturated fatty acid is used to form and fix a toner image on a recording medium, the fatty acid triglyceride remaining in the toner image along with the toner particles can undergo oxidation polymerization with oxygen or the like in the air, whereby the toner particles can be firmly adhered to each other, and the toner particles and the recording medium can be firmly adhered to each other. The unsaturated fatty acid component of the fatty acid triglyceride can undergo oxidation polymerization while covering the surface of the toner image, and therefore, a protective film of the cured fatty acid triglyceride can be formed on the surface of the toner particles. Accordingly, the toner image can be prevented from suffering deterioration due to external physical force, such as friction, the air, light and the like to have excellent long-term stability.

The content of the fatty acid triglyceride in the insulating liquid is preferably from 20 to 90% by weight, more preferably from 30 to 90% by weight, and further preferably from 40 to 90% by weight. According to the constitution, the dispersibility of the toner particles in the liquid developer is particularly improved, and the chemical stability of the liquid developer can be particularly improved.

In the case where the insulating liquid contains the above-described fatty acid monoester, the following advantages can be obtained. The fatty acid monoester contained in the toner particles particularly exhibits the plasticizing effect of the resin material constituting the toner particles. The fatty acid monoester has a relatively small molecular weight and has high affinity with the resin material constituting the toner particles. As a result, the toner particles contain, as the liquid component, the fatty acid monoester contained in the insulating liquid, whereby the toner particles are particularly improved in low temperature fixing property.

In the case where the insulating liquid contains the synthetic ester liquid having the aforementioned characteristics, the following advantages can be obtained. As similar to the fatty acid monoester, the synthetic ester liquid contained in the toner particles effectively plasticizes the resin material constituting the toner particles. The synthetic ester liquid has high affinity with the resin material constituting the toner particles, and as a result, the toner particles contain, as the liquid component, the synthetic ester liquid contained in the insulating liquid, whereby the toner particles are particularly improved in low temperature fixing property. The synthetic ester liquid is chemically stable. Accordingly, the liquid developer containing the synthetic ester liquid as the insulating liquid is stable in characteristics thereof for a prolonged period of time to provide a liquid developer that is particularly excellent in long-term stability.

In the case where the insulating liquid contains the above-described aliphatic hydrocarbon, the following advantages can be obtained. The aliphatic hydrocarbon generally has a high electric resistance and is chemically stable. Accordingly, the liquid developer using the aliphatic hydrocarbon is particularly excellent in developing property and transferring property, and a toner image obtained therewith becomes sharp with less defects. The aliphatic hydrocarbon is a liquid having less hygroscopicity. Accordingly, in the case where the insulating liquid contains the aliphatic hydrocarbon, the insulating liquid can be favorably prevented from absorbing moisture upon storing, whereby the insulating liquid can be prevented from suffering modification (deterioration).

In the case where the insulating liquid contains a silicone oil, the following advantages can be obtained. A silicone oil is an organic compound having a siloxane bond as a skeleton. A silicone oil generally has a high electric resistance. In the case where a silicone oil is used as the insulating liquid, accordingly, the liquid developer has a particularly high electric resistance and is improved in transferring property and developing property of a toner image. The silicone oil has various values in viscosity depending on the kinds thereof, and thus the viscosity of the liquid developer can be optimized by selecting the silicon oil. The silicone oil is generally stable chemically and is less harmful to human health. Accordingly, the liquid developer can be favorably prevented the insulating liquid from being deteriorated upon storing, to provide excellent environmental stability. Furthermore, the liquid developer is safe even in the case where the insulating liquid is leaked outside an image forming apparatus.

The liquid developer (insulating liquid) may contain a dispersant capable of improving dispersibility of the toner particles.

Examples of the dispersant include a polymer dispersant, such as polyvinyl alcohol, carboxymethyl cellulose, polyethylene glycol, Adisper PB821 (a trade name, produced by Ajinomoto Co., Inc.), Solsperse (a trade name, produced by Lubrizol Corp. Japan), a polycarboxylic acid and a salt thereof, a polyacrylic acid metallic salt (such as a sodium salt), a polymethacrylic acid metallic salt (such as sodium salt), a polymaleic acid metallic salt (such as sodium salt), an acrylic acid-maleic acid copolymer metallic salt (such as a sodium salt), a polystyrenesulfonic acid metallic salt (such as a sodium salt) and a polyamine-fatty acid polycondensate, a clay mineral, silica, calcium triphosphate, a tristearic acid metallic salt (such as an aluminum salt), a distearic acid metallic salt (such as an aluminum salt and a barium salt), a stearic acid metallic salt (such as a calcium salt, a lead salt and a zinc salt), a linolenic acid metallic salt (such as a cobalt salt, a manganese salt, a lead salt and a zinc salt), an octanoic acid metallic salt (such as an aluminum salt, a calcium salt and a cobalt salt), an oleic acid metallic salt (such as a calcium salt and a cobalt salt), a palmitic acid metallic salt (such as a zinc salt), a dodecylbenzenesulfonic acid metallic salt (such as a sodium salt), a naphthenic acid metallic salt (such as a calcium salt, a cobalt salt, a manganese salt, a lead salt and a zinc salt) and an abietic acid metallic salt (such as a calcium salt, a cobalt salt, a manganese salt, a lead salt and a zinc salt).

In the case where a polyamine-fatty acid polycondensate is used among the dispersants, the polyamine-fatty acid polycondensate can be favorably attached to the surface of the toner particles, whereby the toner particles can be prevented from suffering unintended aggregation. In addition, a charging property of the toner particles can be further improved.

In the case where a polyamine-fatty acid polycondensate is used, the content of the polyamine-fatty acid polycondensate in the liquid developer is preferably from 0.5 to 6.5 parts by weight, and more preferably from 1.0 to 4.0 parts by weight, per 100 parts by weight of the toner particles. According to the constitution, the advantages obtained by using the polyamine-fatty acid polycondensate can be exhibited further significantly.

The insulating liquid may contain an antioxidant.

The liquid developer (insulating liquid) may contain a charge controlling agent.

Examples of the charge controlling agent include a metallic oxide, such as zinc oxide, aluminum oxide and magnesium oxide, a metallic salt of benzoic acid, a metallic acid of salicylic acid, a metallic acid of an alkylsalicylic acid, a metallic acid of catechol, a metal-containing bisazo dye, a nigrosine dye, a tetraphenylborate derivative, a quaternary ammonium salt, an alkylpyridinium salt, chlorinated polyester and nitrohumic acid.

The insulating liquid preferably has an electric resistance at room temperature (20° C.) of 1.0×10¹¹ Ω·cm or more, more preferably 1.0×10¹² Ω·cm or more, and further preferably 2.0×10¹² Ω·cm or more.

The insulating liquid preferably has a dielectric constant of 3.5 or less.

The viscosity (measured with a vibration viscometer at 25° C. according to JIS Z8809) of the liquid developer constituted by the aforementioned components is preferably 1,000 mPa·s or less. According to the constitution, the liquid developer favorably permeates the recording medium, whereby the fixing property of the toner particles to the recording medium is improved. Furthermore, an image obtained on the recording medium becomes sharp without unevenness, and moreover, the liquid developer becomes suitable particularly for high-speed image formation.

The electric resistance at room temperature (20° C.) of the liquid developer constituted by the aforementioned components is preferably 1.0×10¹¹ Ω·cm or more, and more preferably 1.0×10¹² Ω·cm or more.

### Production Method of Liquid Developer

An embodiment of the production method of the liquid developer of the invention will be described.

The production method of the liquid developer of the embodiment mainly contains a swollen resin liquid preparing step of preparing a swollen resin liquid containing a resin material swollen with an insulating liquid, by heating a composition (resin dispersion liquid) containing the resin material and the insulating liquid, and a resin depositing step of depositing, in the swollen resin liquid, the resin to form resin fine particles (toner particles) containing mainly the resin material and containing therein the insulating liquid, by cooling the swollen resin liquid. The production method of the liquid developer of the embodiment contains, before the swollen resin liquid preparing step, a kneading step of kneading the resin and a colorant to form a kneaded product, and a pulverizing step of pulverizing the kneaded product to obtain a pulverized product. According to the constitution, the liquid developer can be obtained easily and certainly, and the toner particles constituting the liquid developer can contain the insulating liquid easily and certainly. In the case where the resin material is deposited by using the insulating liquid to form the toner particles in this manner, there is no necessity of pulverizing the constitutional materials of the toner particles, and thus an energy saving production method of the liquid developer can be provided. Furthermore, there is no necessity of removing unnecessary liquids, such as distillation, in the production method of the liquid developer of the embodiment. Accordingly, the production method of the liquid developer is excellent in productivity and effectively utilizes the resources.

### Kneading Step

The resin material and the colorant are kneaded to obtain a kneaded product.

The raw material to be kneaded contains the above-described resin material and the colorant. By using the colorant in the raw material, particularly, the air contained in the raw material (particularly, the air entrained in the colorant) can be effectively removed in this step, and thus bubbles can be effectively prevented from being mixed (remaining) in the toner particles. Furthermore, by kneading the resin material and the colorant uniformly, the colorant is uniformly dispersed in the pulverized product to be dispersed in the resin solution described later, whereby the resulting toner particles contains the colorant dispersed therein particularly uniformly. The components of the raw material to be kneaded are preferably mixed in advance.

The kneading operation of the raw material can be carried out by using various kneading machines, such as a continuous type two-roll kneading extruder, a kneader, a batch type three-roll mill, a continuous type two-roll mill, a wheel mixer and a blade type mixer. Among these, a continuous type two-roll kneading extruder is preferably used as the kneading machine. According to the constitution, the raw material can be effectively kneaded, and the air contained in the raw material can be removed.

The raw material to be kneaded may contain the above-described dispersant. According to the constitution, the colorant can be particularly improved in dispersibility and solubility in the swollen resin solution described later, whereby the resulting toner particles contain the colorant dispersed therein particularly uniformly.

### Pulverizing Step

The kneaded product is then pulverized to obtain a pulverized product in the form of minute particles. By pulverizing the kneaded product, the swollen resin liquid described later can be obtained as a uniform solution relatively easily. As a result, the size of the toner particles contained in the liquid developer finally obtained can be reduced, whereby the liquid developer can be favorably used for forming an image with high resolution.

The method of pulverization is not particularly limited, and can be carried out by using various pulverizing machines and crushing machines, such as a ball mill, a vibration mill, a jet mill and a pin mill.

The pulverizing step may be carried out by dividing into plural steps (for example, a coarsely pulverizing step and a finely pulverizing step). Furthermore, such a step as a classifying step may be carried out depending on necessity after the pulverizing step. In the classifying step, for example, a sieve, an air-flow classifier and the like may be used.

### Swollen Resin Liquid Preparing Step

A composition (resin dispersion liquid) containing the pulverized product containing the resin material and the colorant, to which an insulating liquid is added, is then prepared, and the resin dispersion liquid is heated to prepare a swollen resin liquid containing the resin material (pulverized product) swollen with the insulating liquid. The resin dispersion liquid containing the resin material and the insulating liquid is heated in this manner, whereby the resin material is swollen with the insulating liquid in the resin dispersion liquid. According to the procedure, resin fine particles obtained in the resin depositing step described later can contain the insulating liquid inside, and as a result, the toner particles constituting the final liquid developer contain the insulating liquid inside.

As the insulating liquid constituting the resin dispersion liquid, the insulating liquid having been described above can be used.

The resin dispersion liquid may be prepared in any method, and for example, can be obtained by mixing the pulverized product and the insulating liquid with an agitating machine, such as a high-speed agitating machine. According to the procedure, the pulverized product can be uniformly dispersed in the insulating liquid, and the colorant can be certainly dispersed in the insulating liquid.

Examples of the agitating machine that can be used for preparing the resin dispersion liquid include an attritor, a ball mill, a planetary ball mill, a bead mill, a sand mill, a high-speed mixer and a homogenizer, and among these, a high-speed mixer is preferably used. The high-speed mixer may have only one agitating blade or may have plural agitating blades, and an agitating machine having plural agitating blades in orbital motion, each of which rotates by itself, can favorably apply a shearing force to the resin dispersion liquid. Specific examples of the agitating machine of this type include DESPA (produced by Asada Iron Works Co., Ltd.), a planetary mixer, T.K. Hivis Mix Model 2P-03 (produced by Primix Corp.), and T.K. Robomix and T.K. Homo Disper Model 2.5 (produced by Primix Corp.).

The resin dispersion liquid thus obtained is then heated. According to the procedure, the insulating liquid permeates among the molecules of the resin material in the pulverized product to provide the swollen resin liquid containing the resin material in the pulverized product swollen with the insulating liquid.

The resin material (pulverized product) having been swollen with the insulating liquid has flexibility, and the shape thereof is destabilized. The pulverized product in this state is liable to change in shape thereof, and toner particles having an intended particle diameter can be prepared by changing the cooling rate of the swollen resin liquid and/or the rate of agitation thereof in the resin depositing step described later.

The resin dispersion liquid may be heated under agitating the resin dispersion liquid with an agitating machine or the like. According to the procedure, the particle diameter of the pulverized product swollen in the swollen resin liquid can be controlled, whereby resin fine particles having an intended particle diameter can be easily prepared in the resin depositing step described later. Examples of the agitating machine include those described for the preparation of the resin dispersion liquid.

The temperature of the resin dispersion liquid heated is preferably such a temperature that is higher than the melting point of the resin material contained in the resin dispersion liquid. According to the procedure, the resin material in the pulverized product can certainly contain the insulating liquid among the molecules thereof, whereby the pulverized product in the swollen resin liquid can be favorably swollen therewith. Consequently, the particle diameter of the resin fine particles obtained in the resin depositing step can be easily controlled.

In the case where the insulating liquid contains a fatty acid triglyceride, the following advantages can be obtained. Upon heating the resin dispersion liquid, the fatty acid triglyceride has a nature of swelling the resin material but does not have such dissolution power that dissolves the resin material. Accordingly, the resin material constituting the pulverized product can be favorably prevented from being dissolved into the swollen resin liquid. According to the constitution, the particle size distribution of the resin fine particles (toner particles) deposited in the resin depositing step described later can be further narrowed, whereby fluctuation in characteristics, such as charging property, among the toner particles can be certainly prevented from occurring.

The insulating liquid may contain the dispersant described above. According to the constitution, the dispersibility of the pulverized product swollen in the swollen resin liquid is improved, whereby the pulverized product can be certainly prevented from suffering aggregation in the swollen resin liquid, and the particle diameter of the toner particles can be easily controlled.

After preparing the swollen resin liquid in this step, the insulating liquid may be further added thereto, whereby the pulverized product swollen in the swollen resin liquid can be dispersed further uniformly therein, and the concentration of the solid content in the swollen resin liquid can be easily controlled. According to the procedure, resin fine particles having a further uniform particle diameter can be deposited in the swollen resin liquid in the resin depositing step described later.

### Resin Depositing Step

The swollen resin liquid in the heated state is then cooled to deposit the resin material in the swollen resin liquid, whereby resin fine particles (toner particles) containing the insulating liquid inside are formed. The pulverized product (resin material) having been swollen with the insulating liquid by heating is cooled in this manner, whereby a part of the insulating liquid is released from among the molecules of the resin material in the pulverized product, so as to provide the insulating liquid constituting the final liquid developer. The insulating liquid that has not been released from among the molecules of the resin material remains in the resin material as a component constituting the resin fine particles (toner particles). The resin fine particles (toner particles) contain the insulating liquid (liquid component) thereinside and thus have excellent dispersibility in the insulating liquid, and consequently, the liquid developer is improved in storage stability and long-term stability.

The resin fine particles (toner particles) thus deposited in this manner have a non-spherical shape having plural protrusions on the surface thereof. The toner particles having the shape are melted and fixed to a recording medium upon fixing in such a state in that the protrusions on the surface of the toner particles are interdigitated with the unevenness on the surface of the recording medium. In the case where paper is used as the recording medium, in particular, the protrusions on the surface of the toner particles are melted after penetrating into the fibers of the paper, whereby the toner particles can be firmly fixed to the paper through the anchoring effect. A toner image formed by fixing the toner particles expresses surface irregularity of a recording medium (such as paper) to display an image with excellent in stereoscopic appearance.

The cooling rate of the swollen resin liquid varies depending on the combination of the resin material and the insulating liquid used. The cooling rate until the temperature is decreased to the temperature Ti (° C.) (deposition starting temperature), at which the resin material starts to be deposited in the swollen resin liquid upon cooling the swollen resin liquid in a heated state, is not particularly limited, and the cooling rate within the range where the temperature is decreased from Ti (° C.) (or a temperature higher than Ti (° C.) by 5° C. or less) is preferably slower. Specifically, the cooling later is preferably from −1 to −5° C. per hour. According to the procedure, the resin material starts to be deposited in the swollen resin liquid at the time when the temperature becomes lower than Ti (° C.), and the resin material is further deposited on the surface of the resin material having been deposited as nuclei to form the non-spherical resin fine particles (toner particles) having protrusions grown on the surface thereof. In the case where the swollen resin liquid is cooled at a slower rate from Ti (° C.) the resin fine particles deposited in the swollen resin liquid have a uniform particle diameter, whereby coarse particles and extremely fine particles can be certainly prevented from being contained the liquid developer finally obtained.

Upon cooling the swollen resin liquid, the swollen resin liquid is preferably agitated with the agitating machine described above. According to the procedure, the resin fine particles (toner particles) formed have a further uniform particle diameter, whereby coarse particles can be prevented further certainly from being formed as the resin fine particles, and the characteristics of the resulting liquid developer can be further stabilized.

By depositing the resin material in the swollen resin liquid and cooled to room temperature (20° C.) in this manner, a liquid developer having dispersed therein resin fine particles (toner particles) containing the insulating liquid therein can be obtained.

A charge controlling agent, a dispersant and the like may be added in this step. The addition thereof may be carried out before cooling the swollen resin liquid, after completing the deposition of the resin material, or during the cooling operation of the swollen resin liquid.

An insulating liquid may be further added in this step. The insulating liquid may be added during the deposition of the resin material or after completing the deposition of the resin material.

### Image Forming Apparatus

A preferred embodiment of the image forming apparatus according to an embodiment of the invention will be described. The image forming apparatus of the embodiment of the invention forms a color image on a recording medium by using a liquid developer according to the embodiment of the invention having been described above.

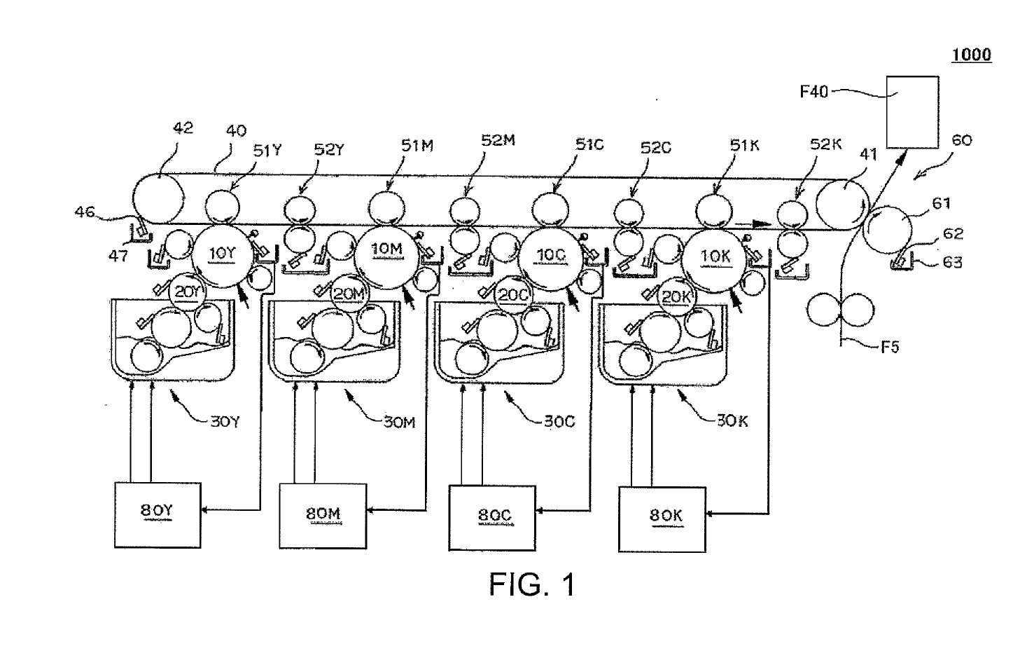

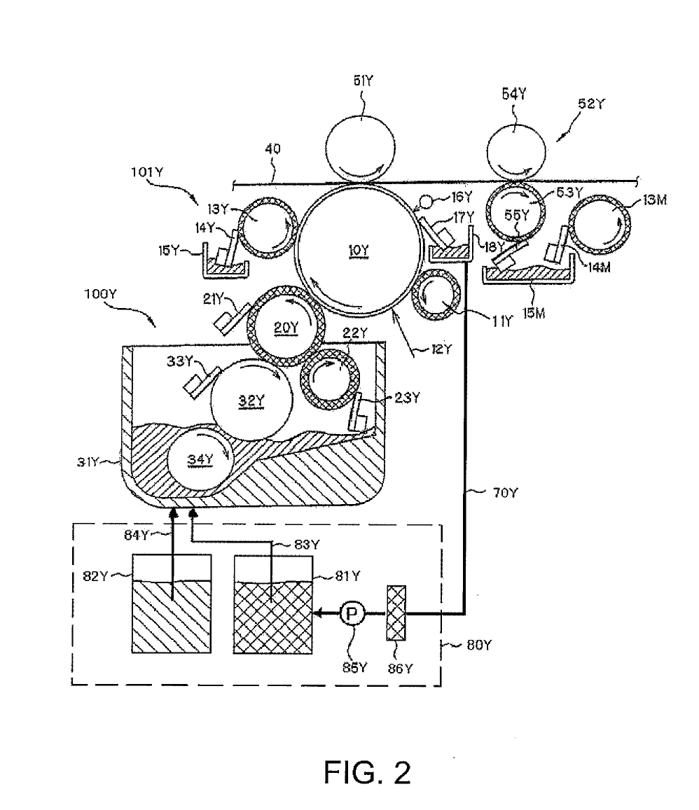

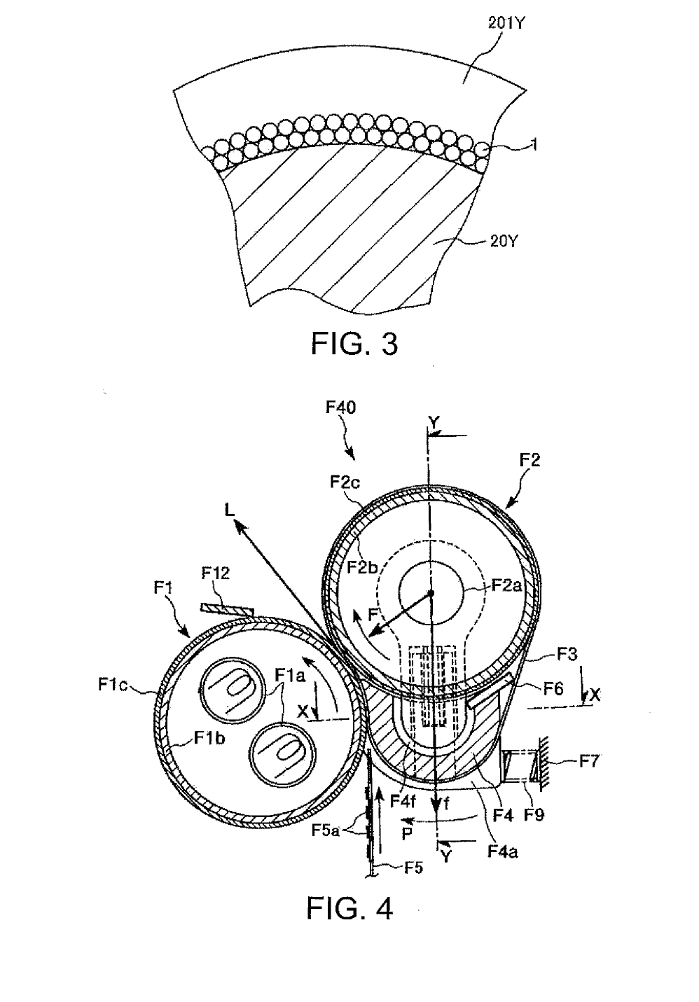

FIG. 1 is a schematic illustration showing an example of an embodiment of an image forming apparatus, to which a liquid developer according to an embodiment of the invention is applied. FIG. 2 is an enlarged illustration of a part of the image forming apparatus shown in FIG. 1. FIG. 3 is a schematic diagram showing the state of the toner particles in a liquid developer layer on a developing roller. FIG. 4 is a cross sectional view showing an example of the fixing device applied to the image forming apparatus shown in FIG. 1.

An image forming apparatus 1000 has, as shown in FIGS. 1 and 2, four developing parts 30Y, 30M, 30C and 30K, an intermediate transferring part 40, a secondary transferring unit (secondary transferring part) 60, a fixing part (fixing device) F40 and four liquid developer feeding parts 80Y, 80M, 80C and 80K.

The developing parts 30Y, 30M and 30C have a function of developing latent images with a yellow liquid developer (Y) a magenta liquid developer (M) and a cyan liquid developer (C) to form monochrome images corresponding to the colors, respectively. The developing part 30K has a function of developing a latent image with a black liquid developer (K) to form a black (K) monochrome image.

The developing parts 30Y, 30M, 30C and 30K have the same constitutions, and therefore, the developing part 30Y is described below.

The developing part 30Y has, as shown in FIG. 2, a photoreceptor 10Y as an example of an image carrying member, and has, along the rotation direction of the photoreceptor 10Y, a charging roller 11Y, an exposing unit 12Y, a developing unit 100Y, a photoreceptor squeezing device 101Y, a primary transfer backup roller 51Y, a destaticizing unit 1GY, a photoreceptor cleaning blade 17Y and a developer recovering part 18Y.

The photoreceptor 10Y has a tubular substrate having on an outer peripheral surface thereof a photoreceptor layer, and is rotatable with the center axis thereof as the center. In this embodiment, the photoreceptor 10Y is rotatable clockwise as shown by the arrow in FIG. 1.

A liquid developer is fed to the photoreceptor 10Y from the developing unit 100Y described later, and a layer of the liquid developer is formed on the surface thereof.

The charging roller 11Y is a device for charging the photoreceptor 10Y, and the exposing unit 12Y is a device for forming a latent image on the charged photoreceptor 10Y by radiating laser light. The exposing unit 12Y has a semiconductor laser, a polygonal mirror, an F-θ lens and the like, and irradiates the photoreceptor 10Y with laser light modulated based on image signals input from a host computer, such as a personal computer and a word processor, which is not shown in the figure.

The developing unit 100Y is a device for developing the latent image formed on the photoreceptor 10Y with the liquid developer according to an embodiment of the invention. The developing unit 100Y will be described in detail later.

The photoreceptor squeezing device 101Y is disposed to face the photoreceptor 10Y on the downstream side in the rotation direction with respect to the developing unit 100Y, and is constituted by a photoreceptor squeezing roller 13Y, a cleaning blade 14Y pressed onto the photoreceptor squeezing roller 13Y for removing the liquid developer attached to the surface of the photoreceptor squeezing roller 13Y, and a developer recovering part 15Y housing the liquid developer thus removed with the cleaning blade 14Y. The photoreceptor squeezing device 101Y has a function of recovering an excessive carrier (insulating liquid) and an unnecessary fogging toner from the developer having been developed on the photoreceptor 10Y to improve the proportion of the toner particles in the developed image.

A primary transfer backup roller 51Y is a device for transferring the monochrome image formed on the photoreceptor 10Y to the intermediate transferring part 40 described later.

The destaticizing unit 16Y is a device for removing remaining charge on the photoreceptor 10Y after transferring the intermediate transfer image to the intermediate transferring part 40 described later with the primary transfer backup roller 51Y.

The photoreceptor cleaning blade 17Y is a rubber member pressed onto the surface of the photoreceptor 10Y and has a function of scraping and removing the liquid developer remaining on the photoreceptor 10Y after transferring the image to the intermediate transferring part 40 described later with the primary transfer backup roller 51Y.

The developer recovering part 18Y has a function of recovering the liquid developer thus removed with the photoreceptor cleaning blade 17Y.

The intermediate transferring part 40 is an endless elastic belt member, which is wound and stretched on a belt driving roller 41 and a tension roller 42 and rotationally driven with the belt driving roller 41 through contact with the primary transfer backup rollers 51Y, 51M, 51C and 51K and the photoreceptors 10Y, 10M, 10C and 10K.

Monochrome images of plural colors formed in the developing parts 30Y, 30M, 30C and 30K are transferred sequentially to the intermediate transfer part 40 with the primary transfer backup rollers 51Y, 51M, 51C and 51K, and the monochrome images of the plural colors are superimposed on each other. According to the operation, a full color developed image (intermediate transfer image) is formed on the intermediate transfer part 40.

The intermediate transfer part 40 retains the monochrome images, which are formed on the plural photoreceptors 10Y, 10M, 10C and 10K and then secondary transferred sequentially to the intermediate transfer part 40, and then secondarily transfers the images at one time to a recording medium F5, such as paper, film and cloth. The recording medium F5 may be a sheet material having rough surface due to fibrous materials thereof, and the elastic belt member is used as the intermediate transfer part 40 for improving the secondary transfer property by following the rough surface of the sheet material upon secondarily transferring the toner image to the recording medium F5.

A cleaning device containing an intermediate transfer part cleaning blade 46 and a developer recovering part 47 is disposed on the side of the tension roller 42, which stretches the intermediate transfer part 40 along with the belt driving roller 41.

The intermediate transfer part cleaning blade 46 has a function of scraping and removing the liquid developer attached to the intermediate transfer part 40 after transferring the image to the recording medium F5 with a secondary transfer roller 61.

The developer recovering part 47 has a function of recovering the liquid developer removed with the intermediate transfer part cleaning blade 46.

An intermediate transfer part squeezing device 52Y is disposed on the downstream side of the primary transfer backup roller 51Y in the moving direction of the intermediate transfer part 40.

The intermediate transfer part squeezing device 52Y is provided as a device for removing an excessive amount of the insulating liquid from the liquid developer transferred to the intermediate transfer part 40 in the case where the liquid developer transferred is not in a favorable dispersed state.

The intermediate transfer part squeezing device 52Y is constituted by an intermediate transfer part squeezing roller 53Y, an intermediate transfer part squeezing backup roller 54Y disposed to face the intermediate transfer part squeezing roller 53Y with the intermediate transfer part 40 intervening between them, an intermediate transfer part squeezing cleaning blade 55Y pressed onto the intermediate transfer part squeezing roller 53Y to clean the surface thereof, and a developer recovering part 15M.

The intermediate transfer part squeezing device 52Y has a function of recovering an excessive amount of the carrier from the developer primarily transferred to the intermediate transfer part 40 to increase the content of the toner particles in the developed image, and a function of recovering an unnecessary fogging toner. The developer recovering part 15M is a recovering mechanism for the carrier recovered by the cleaning blade 14M of the photoreceptor squeezing roller of magenta color disposed on the downstream side in the moving direction of the intermediate transfer part 40, and is also used as a recovering mechanism for the carrier recovered by the intermediate transfer part squeezing cleaning blade 55Y of the intermediate transfer part squeezing roller 53Y. Accordingly, the developer recovering parts 15M, 15C and 15K (the developer recovering parts 15C and 15K are not shown in the figures) of the image carrying member squeezing devices of the second or later colors in the moving direction of the intermediate transfer part 40 are used respectively as the developer recovering parts of the intermediate transfer part squeezing parts 52Y, 52M and 52C disposed in the downstream side of the preceding primary transfer backup rollers 51Y, 51M and 51C in the moving direction of the intermediate transfer part 40, whereby the intervals of them can be maintained constant, and the structure is simplified to enable miniaturization.

The secondary transfer unit 60 has a secondary transfer roller 61 disposed to face the belt driving roller 41 with the intermediate transfer part 40 intervening between them, and has a cleaning device containing a cleaning blade 62 for the secondary transfer roller 61 and a developer recovering part 63.

In the secondary transfer unit 60, the recording medium F5 is transported and fed according to the timing when the intermediate transfer image formed by superimposing the monochrome images on the intermediate transfer part 40 reaches the transfer position of the secondary transfer unit 60, and thus the intermediate transfer image is secondarily transferred to the recording medium F5.

The toner image (transferred image) F5a thus transferred to the recording medium F5 in the secondary transfer unit 60 is transported to the fixing part F40 and fixed therein.

The cleaning blade 62 has a function of scraping and removing the liquid developer attached to the secondary transfer roller 61 after transferring the image to the recording medium F5 with the secondary transfer roller 61.

The developer recovering part 63 has a function of recovering the liquid developer removed with the cleaning blade 62.

The developing units 10Y, 100M, 100C and 100K will be described in detail below. The developing unit 100Y will be described as a representative example.

The developing unit 100Y has, as shown in FIG. 2, a liquid developer storing part 31Y, a coating roller 32Y, a restricting blade 33Y, a developer agitating roller 34Y, a developing roller 20Y, a developing roller cleaning blade 21Y and a developer compressing roller (compressing unit) 22Y.

The liquid developer storing part 31Y has a function of storing the liquid developer for developing a latent image formed on the photoreceptor 10Y.

The coating roller 32Y has a function of feeding the liquid developer to the developing roller 20Y.

The coating roller 32Y is a so-called anilox roller, which is a metallic roller, such as an iron roller, having grooves formed uniformly and helically on the surface thereof and having been plated with nickel, and has a diameter of about 25 mm. In this embodiment, plural grooves are formed slantwise with respect to the rotation direction of the coating roller 32Y by a cutting process, a rolling process or the like. The coating roller 32Y is in contact with the liquid developer while rotating clockwise to retain the liquid developer stored in the liquid developer storing part 31Y in the grooves, and transports the retained liquid developer to the developing roller 20Y.

The restricting blade 33Y is in contact with the surface of the coating roller 32Y to restrict the amount of the liquid developer on the coating roller 32Y. Specifically, the restricting blade 33Y scrapes the excessive liquid developer on the coating roller 32Y to quantitate the liquid developer on the coating roller 32Y, which is to be fed to the developing roller 20Y. The restricting blade 33Y is formed of urethane rubber as an elastic material and supported with a restricting blade supporting member formed of a metal, such as iron. The restricting blade 33Y is provided on the side where the coating roller 32Y is rotated to come out from the liquid developer as viewed from the vertical plane A (i.e., on the left side as viewed from the vertical plane A in FIG. 2). The restricting blade 33Y has a rubber hardness of about 77 according to JIS-A, and the hardness of the restricting blade 33Y at the part in contact with the surface of the coating roller 32Y (about 77) is lower than the hardness of the developing roller 20Y described later at the part in contact with the surface of the coating roller 32Y (about 85) The excessive liquid developer thus scraped is recovered to the liquid developer storing part 31Y for reuse.

The developer agitating roller 34Y has a function of agitating the liquid developer to form a uniform dispersed state. By using the developer agitating roller 34Y, even in the case where plural toner particles 1 are aggregated, the respective toner particles 1 can be favorably dispersed. In the case where the liquid developer that has been once used is reused, in particular, the toner particles 1 can be favorably dispersed.

In the liquid developer storing part 31Y, the toner particles 1 in the liquid developer have positive charge, and the liquid developer in a uniform dispersed state by agitating with the developer agitating roller 34Y is drawn up from the liquid developer storing part 31Y through rotation of the coating roller 32Y, and then fed to the developing roller 20Y after restricting the amount of the liquid developer with the restricting blade 33Y.

The developing roller 20Y retains the liquid developer and transports the liquid developer to the developing position facing the photoreceptor 10Y for developing the latent image carried on the photoreceptor 10Y with the liquid developer.

The developing roller 20Y has a liquid developer layer 201Y formed on the surface thereof by feeding the liquid developer from the coating roller 32Y.

The developing roller 20Y has an inner core constituted by a metal, such as iron, having thereon an electroconductive elastic layer, and has a diameter of about 20 mm. The elastic layer has a two-layer structure containing an urethane rubber layer having a rubber hardness of about 30 according to JIS-A and a thickness of about 5 mm as an inner layer, and an urethane rubber layer having a rubber hardness of about 85 according to JIS-A and a thickness of about 30 mm as a surface (outer) layer. The developing roller 20Y is in contact with the coating roller 32Y and the photoreceptor 10Y with the surface layer as a contact part under pressure in an elastically deformed state.

The developing roller 20Y is rotatable with the center axis thereof as the center, and the center axis is positioned downward with respect to the center rotation axis of the photoreceptor 10Y. The developing roller 20Y is rotated in the direction (i.e., the anticlockwise direction in FIG. 2) opposite to the rotation direction (i.e., the clockwise direction in FIG. 2) of the photoreceptor 10Y. An electric field is formed between the developing roller 20Y and the photoreceptor 10Y upon developing the latent image formed on the photoreceptor 10Y.

The developer compressing roller 22Y is a device having a function of making the liquid developer retained by the developing roller 20Y into a compressed state. In other words, the developer compressing roller 22Y is a device having a function of applying an electric field having the same polarity as the toner particles 1 to the liquid developer layer 201Y, thereby localizing the toner particles 1 to the vicinity of the surface of the developing roller 20Y within the liquid developer layer 201Y as shown in FIG. 3. By localizing toner particles in this manner, the developing density (developing efficiency) can be improved, and a sharp image with high quality can be obtained thereby.

A cleaning blade 23Y is provided on the developer compressing roller 22Y.

The cleaning blade 23Y has a function of removing the liquid developer attached to the developer compressing roller 22Y. The liquid developer removed with the cleaning blade 23Y is recovered into the liquid developer storing part 31Y for reuse.

The developing unit 100Y has a developing roller cleaning blade 21Y formed of rubber in contact with the surface of the developing roller 20Y. The developing roller cleaning blade 21Y is a device for scraping and removing the liquid developer remaining on the developing roller 20Y after completing development at the developing position. The liquid developer removed by the developing roller cleaning blade 21Y is recovered into the liquid developer storing part 31Y for reuse.

The image forming apparatus 1000 has, as shown in FIGS. 1 and 2, four liquid developer feeding parts 80Y, 80M, 80C and 80K for feeding the liquid developer to the developing parts 30Y, 30M, 30C and 30K. The liquid developer feeding parts 80Y, 80M, 80C and 80K have the same constitutions, and therefore, the liquid developer feeding part 89Y is described below.

The liquid developer feeding part 80Y has a recovered liquid developer storing part 81Y, a liquid developer replenishing part 82Y, transporting devices 83Y and 84Y, a pump 85Y and a filter 86Y.

The recovered liquid developer storing part 81Y stores mainly the recovered liquid developer recovered by the developer recovering part 18Y, and the recovered liquid developer is fed to the liquid developer storing part 31Y of the developing part 30Y with the transporting device 83Y. The liquid developer replenisher storing part 82Y stores the liquid developer, and the liquid developer is fed to the liquid developer storing part 31Y with the transporting device 84Y. The formulations of the liquid developer stored in the liquid developer replenisher storing part 82Y and the recovered liquid developer stored in the recovered liquid developer storing part 81Y may be the same as or different from that of the liquid developer stored in the liquid developer storing part 31Y.

The liquid developer recovered to the developer recovering part 31Y is fed to the liquid developer feeding part 80Y through a transporting path 70Y.

A pump 85Y is provided on the transporting path 70Y, and the liquid developer recovered to the developer recovering part 18Y is transported to the recovered liquid developer storing part 81Y with the pump 85Y.

A filter 86Y is provided on the transporting path 70Y, with which coarse particles, foreign matters and the like can be removed from the recovered liquid developer. The solid contents including coarse particles, foreign matters and the like thus removed with the filter 86Y are detected with a detecting unit, which is not shown in the figures, for detecting the state of the filter. The filter 86Y is replaced based on the detection result thereof. According to the constitution, the filtering function of the filter 86Y can be stably maintained.

The fixing part will be described.

The fixing part F40 fixes an unfixed toner image F5a formed in the developing part, the transferring part and the like to a recording medium F5.

As shown in FIG. 4, the fixing device F40 has a heat fixing roller F1, a pressure roller F2, a heat resistant belt F3, a belt stretching member F4, a cleaning member F6, a frame F7 and a spring F9.

The heat fixing roller (fixing roller) F1 has a roller substrate F1b constituted by a tubular member, an elastic member F1c covering the outer periphery of the roller substrate F1b, and columnar halogen lamps F1a as a heat source inside the roller substrate F1b, and is rotatable in the anticlockwise direction shown by the arrow in the figure.

Two columnar halogen lamps F1a and F1a constituting a heat source are installed inside the heat fixing roller F1, and heating elements of the columnar halogen lamps F1a and F1a are disposed at positions different from each other. The columnar halogen lamps F1a and F1a are selectively turned on, whereby the temperatures are controlled under different conditions including the fixing nip position where the heat resistant belt F3 described later is wound on the heat fixing roller F1 and the position where the belt stretching member F4 described later is in contact with the heat fixing roller F1, and under different conditions including a recording medium having a large width and a recording medium having a small width.

The pressure roller F2 is disposed to face the heat fixing roller F1 and applies pressure to the recording medium F5 having an unfixed toner image F5a, through the heat resistant belt F3 described later.

The pressure roller F2 has a roller substrate F2b constituted by a tubular member, and an elastic member F2c covering the outer periphery of the roller substrate F2b, and is rotatable in the clockwise direction shown by the arrow in the figure.

A PFA layer is provided as a surface layer of the elastic member F1c of the heat fixing roller F1. According to the constitution, the elastic members F1c and F2c undergo elastic deformation in the substantially same manner to form a so-called horizontal nip although the elastic members F1c and F2c are different from each other in thickness, and no difference is formed in conveying speed between the peripheral speed of the heat fixing roller F1 and the speed of the heat resistant belt F3 or the recording medium F5 described later, whereby the image fixing operation can be carried out considerably stably.

The heat resistant belt F3 is an endless loop belt that is movably stretched on the outer peripheries of the pressure roller F2 and the stretching member F4 and held under pressure between the heat fixing roller F1 and the pressure roller F2.

The heat resistant belt F3 has a thickness of 0.03 mm or more and is formed of a seamless belt having a two-layer structure containing a front surface (i.e., the side in contact with the recording medium F5) formed of PFA and a back surface (i.e., the side in contact with the pressure roller F2 and the belt stretching member F4) formed of polyimide. The heat resistant belt F3 is not limited thereto and can be formed of other materials, such as a metallic tube, such as a stainless steel tube and a nickel electroformed tube, and a heat resistant resin tube, such as a silicone tube.

The belt stretching member F4 is disposed on the upstream side of the fixing nip part of the heat fixing roller F1 and the pressure roller F2 in the conveying direction of the recording medium F5 oscillatable in the direction shown by the arrow P with the rotation axis F2a of the pressure roller F2 as the center.

The belt stretching member F4 stretches the heat resistant belt F3 in the tangential direction of the heat fixing roller F1 under the state where the recording medium F5 does not pass through the fixing nip part. There are some cases where the recording medium F5 is not smoothly inserted to the fixing nip part and is wrinkled at the edge thereof upon fixing, in the case where the fixing pressure is too large at the initial position, at which the recording medium F5 is inserted to the fixing nip part. By stretching the heat resistant belt F3 in the tangential direction of the heat fixing roller F1, however, an introducing port, to which the recording medium F5 can be smoothly inserted, can be formed, whereby the recording medium F5 can be stably inserted to the fixing nip part.

The belt stretching member F4 is a belt sliding member having a substantially semilunar shape that is interfit inside the heat resistant belt F3 and applies a tension f to the heat resistant belt F3 associated with the pressure roller F2 (the heat resistant belt F3 slides on the belt stretching member F4). The belt stretching member F4 is disposed at such a position that the nip part is formed by winding the heat resistant belt F3 thereon on the side of the heat fixing roller F1 with respect to the tangential direction L of the contact part under pressure of the heat fixing roller F1 and the pressure roller F2. A projected wall F4a is provided as being protruded from one end or both ends in the axial direction of the belt stretching member F4, and in the case where the heat resistant belt F3 is deviated toward one side in the axial direction, the deviation of the heat resistant belt F3 is regulated by making the heat resistant belt F3 in contact with the projected wall F4a. A spring F9 is provided in a compressed state between the side of the projected wall F4a opposite to the heat fixing roller F1 and the frame F7 to press lightly the projected wall F4a of the belt stretching member F4 onto the heat fixing roller F1, whereby the belt stretching member F4 is in contact under sliding with the heat fixing roller F1 for positioning.

The position where the belt stretching member F4 is lightly pressed onto the heat fixing roller F1 forms the nip start position, and the position where the pressure roller F2 is pressed onto the heat fixing roller F1 forms the nip end position.

In the fixing part F40, the recording medium F5 having an unfixed toner image F5a formed thereon is inserted to the fixing nip part from the nip start position, and then it passes between the heat resistant belt F3 and the heat fixing roller F1 and exits from the nip end position, whereby the unfixed toner image F5a formed on the recording medium F5 is fixed. Subsequently, the recording medium F5 is discharged in the tangential direction L of the contact part under pressure of the heat fixing roller F1 and the pressure roller F2.

The cleaning member F6 is disposed between the pressure roller F2 and the belt stretching member F4.

The cleaning member F6 is in contact under sliding with the inner surface of the heat resistant belt F3 to clean foreign matters and abrasion powder on the inner surface of the heat resistant belt F3. The heat resistant belt F3 is refreshed by cleaning foreign matters and abrasion powder to reduce the destabilizing factor on friction coefficient described above. A concaveportion F4f is provided on the belt stretching member F4 for housing the foreign matters and abrasion powder removed from the heat resistant belt F3.

The fixing part F40 has a removing blade (removing unit) F12 that removes the insulating liquid attached to (remaining on) the surface of the heat fixing roller F1 after fixing the toner image F5a to the recording medium F5. The removing blade F12 removes the insulating liquid and simultaneously can remove the toner and the like transferred to the heat fixing roller F1 upon fixing.

For stably driving the heat resistant belt F3, which is stretched on the pressure roller F2 and the belt stretching member F4, with the pressure roller F2, the friction coefficient between the pressure roller F2 and the heat resistant belt F3 may be set larger than the friction coefficient between the belt stretching member F4 and the heat resistant belt F3. However, there are cases where the friction coefficient is destabilized due to insertion of foreign matters between the heat resistant belt F3 and the pressure roller F2 or the heat resistant belt F3 and the belt stretching member F4, or abrasion at the contact part of the heat resistant belt F3 with the pressure roller F2 or the belt stretching member F4.

Therefore, the winding angle of the heat resistant belt F3 on the belt stretching member F4 is set smaller than the winding angle of the heat resistant belt F3 on the pressure roller F2, and the diameter of the belt stretching member F4 is set smaller than the diameter of the pressure roller F2. According to the constitution, the length where the heat resistant belt F3 is in contact under sliding on the belt stretching member F4 is short to avoid the destabilizing factors due to time-lapse deterioration and external disturbance, whereby the heat resistant belt F3 can be stably driven with the pressure roller F2.

The heat applied by the heat fixing roller F1 (fixing temperature) is preferably from 80 to 200° C., more preferably from 100 to 180° C., and further preferably from 100 to 150° C. Since the liquid developer of the embodiment of the invention is excellent in fixing property at a low temperature, a toner image can be firmly fixed to a recording medium even at the relatively low fixing temperature.

The invention has been described with reference to the preferred embodiments, but the invention is not construed as being limited thereto.

For example, the liquid developer according to an embodiment of the invention is not limited to one applied to the image forming apparatus described above.

The liquid developer according to an embodiment of the invention is not limited to those obtained in the production methods described above. For example, the resin dispersion liquid in the embodiment is prepared by using the pulverized product, which is produced by kneading and pulverizing the colorant and the resin material, but the resin dispersion liquid may not be produced with a pulverized product and may be obtained, for example, by directly mixing the insulating liquid, the colorant and the resin material. A kneaded product obtained by kneading the colorant and the resin material along with the liquid constituting the insulating liquid may be coarsely pulverized, and then the pulverized product thus obtained may be pulverized and dispersed in the insulating liquid to form a liquid developer. The toner particles can certainly contain the insulating liquid inside according to the method.

### EXAMPLES

### (1) Production of Liquid Developer

### Example 1

### Preparation of Colorant Master (Kneading Step and Pulverizing Step)

A mixture of 40 parts by weight of an ethylene-methacrylic acid copolymer (melting point Tm: 98° C., Vicat softening point Tv: 78° C., Nucrel N410, a trade name, produced by Du Pont-Mitsui Polychemicals Co./Ltd.) as a resin material, 50 parts by weight of a cyan pigment (Pigment Blue 15:3, produced by Dainichiseika Color & Chemicals Mfg. Co., Ltd.) as a colorant, and 10 parts by weight of a dispersant (Adisper PB821, a trade name, produced by Ajinomoto Co., Inc.) was prepared. The components were mixed with a 20-L Henschel mixer to provide a raw material for a colorant master.

The raw material was kneaded with a biaxial kneading extruder heated to 120° C. to provide a kneaded product. The kneaded product extruded from the extrusion port of the biaxial kneading extruder was cooled (kneading step).

The kneaded product thus cooled was coarsely pulverized to form powder having an average particle diameter of 2.0 mm or less, thus a colorant master (pulverized product) was obtained. A hammer mill was used for pulverization of the kneaded product (pulverizing step).

### Swollen Resin Liquid Preparing Step

50 parts by weight of the resulting colorant master (pulverized product), 50 parts by weight of an ethylene-methacrylic acid copolymer (Nucrel N410, a trade name, produced by Du Pont-Mitsui Polychemicals Co., Ltd.) as an additional resin material, and 100 parts by weight of soybean oil (soybean refined oil, produced by J-oil Mills, Inc.) were placed in a high-speed agitating machine having two rotary blades (T.K. Hivis Mix Model 2P-03, produced by Primix Corp.). In the high-speed agitating machine used in this example, two rotary blades were in planetary motion, i.e., in orbital motion and rotation by itself simultaneously. While the high-speed agitating machine was operated for agitation at an orbital revolution number of 90 rpm and a self-rotation number of 220 rpm, the temperature was increased from room temperature (20° C.) to 120° C. over 1.5 hours. The content of the agitating machine became a viscous liquid of the resin having been swollen and softened. Thereafter, the content was agitated under the same conditions at 120° C. for 0.5 hour, and 300 parts by weight of soybean oil (soybean refined oil, produced by J-Oil Mills, Inc.) was then added to the agitating machine, followed by further agitating continuously under the same conditions for 0.5 hour, so as to provide a swollen resin liquid.

### Resin Depositing Step

After the rotation number of the high-speed agitating machine having the resulting swollen resin liquid charged therein was controlled to an orbital revolution number of 50 rpm and a self-rotation number of 100 rpm, the temperature was decreased from 120° C. to 80° C. at a cooling rate of −25° C. per hour, and then decreased from 80° C. to 55° C. at a cooling rate of −5° C. per hour. Upon cooling the swollen resin liquid, it was confirmed that the resin material was deposited at a temperature in a range of from 75 to 60° C. Thereafter, the temperature was decreased from 55° C. to room temperature (20° C.) at a cooling rate of −25° C. per hour to provide a resin fine particle dispersion liquid having resin fine particles (toner particles) dispersed in an insulating liquid (soybean oil).

5 parts by weight of zirconium octoate (Octope Zr, produced by Hope Chemical Co., Ltd.) as a charge controlling agent and 2 parts by weight of a polyamine fatty acid polymer (Solsperse 11200, produced by Lubrizol Corp. Japan) as a dispersant were added to the resulting resin fine particle dispersion liquid charged in the high-speed agitating machine, and the mixture was agitated at an orbital revolution number of 50 rpm and a self-rotation number of 100 rpm to provide a cyan liquid developer. The average particle diameter by volume of the resin fine particles was measured with Mastersizer 2000 (produced by Malvern Instruments, Ltd.). The average particle diameter was 1.9 μm, and the amount of coarse particles having a diameter exceeding 5 μm was less than 1% by volume. The resulting liquid developer was filtered, and the toner particles were measured for melting point. The melting point was 90° C., which was lower than the melting point (98° C.) of the used resin material (ethylene-methacrylic acid copolymer). It is considered that this is because the soybean oil remains among the molecular chains of the resin material (ethylene-methacrylic acid copolymer) constituting the toner particles to plasticize the resin. The melting point was measured according to JIS K7121 1987.

### Examples 2 to 8

Liquid developers were produced in the same manner as in Example 1 except that the kinds and the contents of the resin material and the insulating liquid, and the cooling conditions in the resin depositing step were changed as shown in Table 1.

### Comparative Example 1

A mixture of 40 parts by weight of a polyester resin (glass transition temperature Tg: 47° C., melting point Tm: 90° C.) as a resin material, 50 parts by weight of a cyan pigment (Pigment Blue 15:3, produced by Dainichiseika Color & Chemicals Mfg. Co., Ltd.) as a colorant, and 10 parts by weight of a dispersant (Adisper PBB21, a trade name, produced by Ajinomoto Co., Inc.) was prepared. The components were mixed with a 20-L Henschel mixer to provide a raw material for a colorant master.

The raw material was kneaded with a biaxial kneading extruder heated to 120° C. to provide a kneaded product. The kneaded product extruded from the extrusion port of the biaxial kneading extruder was cooled.

The kneaded product thus cooled was coarsely pulverized to form powder having an average particle diameter of 1.0 mm or less, thus a colorant master (pulverized product) was obtained. A hammer mill was used for pulverization of the kneaded product.

50 parts by weight of the pulverized product thus obtained and 50 parts by weight of a polyester resin (glass transition temperature Tg: 47° C., melting point Tm: 90° C.) were kneaded with a biaxial kneading extruder heated to 120° C., and then cooled and coarsely pulverized to provide a colored raw material in a powder form having an average particle diameter of 1.0 mm or less.

20 parts by weight of the colored raw material, 80 parts by weight of an aliphatic hydrocarbon (Cosmo SP-10, produced by Cosmo Oil Lubricants Co., Ltd.) as an insulating liquid, 1 part by weight of zirconium octoate (Octope Zr, produced by Hope Chemical Co., Ltd.) as a charge controlling agent, and 2 parts by weight of a polyamine fatty acid polymer (Solsperse 11200, produced by Lubrizol Corp. Japan) as a dispersant were placed in a planetary ball mill (Planet H, produced by Gokin Planetaring, Inc.), to which zirconia balls having a diameter 1 mm were further added, and the colored raw material was pulverized and dispersed for 24 hours. Thus, a liquid developer was obtained. The average particle diameter by volume of the resin fine particles was measured with Mastersizer 2000 (produced by Malvern Instruments, Ltd.). The average particle diameter was 3.8 μm, and the amount of coarse particles having a diameter exceeding 10 μm contained was 10% by volume. The resulting liquid developer was filtered, and the toner particles were measured for melting point. The melting point was 90° C., which was the same as the melting point of the resin material used (polyester resin). The melting point was measured according to JIS K7121 1987.

### Comparative Example 2

A liquid developer was produced in the same manner as in Comparative Example 1 except that soybean oil (soybean refined oil, produced by J-Oil Mills, Inc.) was used as the insulating liquid instead of the aliphatic hydrocarbon (Cosmo SP-10, produced by Cosmo Oil Lubricants Co., Ltd.). The toner particles in the liquid developer thus obtained had a particle diameter that was substantially the same as the particle diameter of the colored raw material before pulverizing with the planetary ball mill, and thus no pulverization proceeded.

### Comparative Example 3

A liquid developer was produced in the same manner as in Comparative Example 2 except that an ethylene-methacrylic acid copolymer (melting point Tm: 98° C., Vicat softening point Tv: 78° C., Nucrel N410, a trade name, produced by Du Pont-Mitsui Polychemicals Co., Ltd.) was used instead of the polyester resin. The toner particles in the liquid developer thus obtained had a particle diameter that was substantially the same as the particle diameter of the colored raw material before pulverizing with the planetary ball mill, and thus no pulverization proceeded.

### Comparative Example 4

A liquid developer was produced in the same manner as in Example 1.

The toner particles dispersed in the insulating liquid (soybean oil) were filtered, and after completely removing the soybean oil attached to the surface of the toner particles, the toner particles were dispersed in an aliphatic hydrocarbon (Cosmo SP-10, produced by Cosmo Oil Lubricants Co., Ltd.) in the same amount as the soybean oil having been removed, so as to provide a liquid developer.

The resin materials and the insulating liquids used for producing the liquid developers, the cooling conditions in the resin depositing step, the liquids confirmed as the liquid component contained in the toner particles by the gas chromatography method described later, and the melting points of the toner particles of Examples and Comparative Examples are shown in Table 1 below.

In Table 1, as the resin material, the polyester resin is represented by PEs, and the ethylene-methacrylic acid copolymer is represented by EMAA. In the Table, HO rapeseed oil represents higholeic rapeseed oil (Canola Oil, a trade name, produced by The Nisshin OilliO Group, Ltd.), soybean oil fatty acid methyl ester represents soybean oil fatty acid methyl ester (produced by The Nisshin OilliO Group, Ltd.), methyl laurate represents methyl laurate (Paster M-12, a trade name, produced by Lion Corp.), methyl myristate represents methyl myristate (Paster M-14, a trade name, produced by Lion Corp.), and Prifer 6813 represents a synthetic ester liquid (an ester non-VOC solvent, aniline point: −10° C., produced by UNIQEMA). In the column of the contents of the constitutional components of the liquid developers, the contents in the liquid developers are shown. All the liquids (insulating liquids) used in Examples and Comparative Examples had an initial boiling point of 140° C. or more measured according to JIS K2254. All the liquid developers of Examples and Comparative Examples had a viscosity of 1,000 mPa·s or less measured with a vibration viscometer at 25° C. according to JIS Z8809.

In Table 1, the melting point of the resin material measured according to JIS K7121 1987 is represented by Tm (° C.) In the column of “Vicat softening point” in the table, the Vicat softening point Tv (° C.) measured according to JIS K7026 1999 is shown for the other resin materials than the polyester resin, and the glass transition temperature Tg (° C.) measured according to JIS K7121 is shown for the polyester resin.

A part of each of the liquid developers of Examples and Comparative Examples was collected, from which a cake (toner particles) was separated by centrifugation. The liquid component contained in the solid content was extracted and then quantitatively analyzed by a gas chromatography method. As a result, in Examples, the toner particles contained the insulating liquid constituting the liquid developer of each of Examples, but in Comparative Examples, the insulating liquid constituting the liquid developer of each of Comparative Examples was not confirmed in the toner particles.

TABLE 1

| | Resin material | | | | | | | |
|---|---|---|---|---|---|---|---|---|
| | | Vicat | Melting | | Insulating liquid | | | |
| | | softening | point | Content | | Content | | Content |
| | | point Tv | Tm | (% by | | (% by | | (% by |
| | Kind | (° C.) | (° C.) | weight) | Kind | weight) | Kind | weight) |
| Example 1 | EMAA | 78 | 98 | 13.8 | soybean | 78.9 | — | — |
| | | | | | oil | | | |
| Example 2 | EMAA | 78 | 98 | 13.8 | HO | 47.3 | soybean oil | 31.6 |
| | | | | | rapeseed | | fatty acid | |
| | | | | | oil | | methyl | |
| | | | | | | | ester | |
| Example 3 | EMAA | 78 | 98 | 13.8 | Cosmo | 39.4 | methyl | 39.4 |
| | | | | | SP-10 | | laurate | |
| Example 4 | EMAA | 62 | 89 | 13.8 | HO | 78.9 | | |
| | | | | | rapeseed | | | |
| | | | | | oil | | | |
| Example 5 | EMAA | 62 | 89 | 13.8 | HO | 47.3 | Prifer | 31.6 |
| | | | | | rapeseed | | 6813 | |
| | | | | | oil | | | |
| Example 6 | PEs | 47 (Tg) | 90 | 13.8 | soybean | 47.3 | methyl | 31.6 |
| | | | | | oil | | myristate | |
| Example 7 | EMAA | 78 | 98 | 13.8 | Cosmo | 78.9 | — | — |
| | | | | | SP-10 | | | |
| Example 8 | EMAA | 78 | 98 | 13.8 | soybean | 78.9 | — | — |
| | | | | | oil | | | |
| Comparative | PEs | 47 (Tg) | 90 | 13.6 | Cosmo | 77.7 | — | — |
| Example 1 | | | | | SP-10 | | | |
| Comparative | PEs | 47 (Tg) | 90 | 13.6 | soybean | 77.7 | — | — |
| Example 2 | | | | | oil | | | |
| Comparative | EMAA | 78 | 98 | 13.6 | soybean | 77.7 | — | — |
| Example 3 | | | | | oil | | | |
| Comparative | EMAA | 78 | 98 | 13.8 | Cosmo | 78.0 | — | — |
| Example 4 | | | | | SP-10 | | | |

| | Resin depositing step | | | | | |
|---|---|---|---|---|---|---|
| | (cooling conditions) | | | | | |
| | Deposition | Cooling rate | | | Toner particles | |
| | starting | −25° C. | −5° C. | −25° C. | Liquid | Melting |
| | temperature | per | per | per | component | point |
| | (° C.) | hour | hour | hour | contained | (° C.) |
| Example 1 | 75 | 120-80 | 80-55 | 55-20 | soybean | 90 |
| | | (° C.) | (° C.) | (° C.) | oil | |
| Example 2 | 70 | 120-70 | 70-45 | 45-20 | HO rapeseed | 80 |
| | | (° C.) | (° C.) | (° C.) | oil, soybean | |
| | | | | | oil fatty | |
| | | | | | acid methyl | |
| | | | | | ester | |
| Example 3 | 75 | 120-80 | 80-55 | 55-20 | methyl | 88 |
| | | (° C.) | (° C.) | (° C.) | laurate | |
| Example 4 | 70 | 120-75 | 75-50 | 50-20 | HO | 82 |
| | | (° C.) | (° C.) | (° C.) | rapeseed | |
| | | | | | oil | |
| Example 5 | 70 | 120-70 | 70-45 | 45-20 | HO rapeseed | 81 |
| | | (° C.) | (° C.) | (° C.) | oil, Prifer | |
| | | | | | 6813 | |
| Example 6 | 80 | 115-80 | 80-55 | 55-20 | soybean oil, | 88 |
| | | (° C.) | (° C.) | (° C.) | methyl | |
| | | | | | myristate | |
| Example 7 | 90 | 120-90 | 90-60 | 60-20 | Cosmo | 95 |
| | | (° C.) | (° C.) | (° C.) | SP-10 | |
| Example 8 | 75 | 120-20 | — | — | soybean | 90 |
| | | (° C.) | | | oil | |
| Comparative | — | — | — | — | — | 90 |
| Example 1 | | | | | | |
| Comparative | — | — | — | — | — | 90 |
| Example 2 | | | | | | |
| Comparative | — | — | — | — | — | 98 |
| Example 3 | | | | | | |
| Comparative | 75 | 120-80 | 80-55 | 55-20 | soybean | 90 |
| Example 4 | | (° C.) | (° C.) | (° C.) | oil | |

The liquid developers thus obtained were evaluated in the following manner.

### (2-1) Storage Stability

The liquid developers obtained in Examples and Comparative Examples were allowed to stand under an environment at a temperature of from 15 to 25° C. for 6 months. Thereafter, the state of the toner contained in the liquid developer was visually observed and evaluated based on the following five grades.
A: Completely no floatage or precipitation due to aggregation of toner particles found
B: Substantially no floatage or precipitation due to aggregation of toner particles found
C: Slight floatage and precipitation due to aggregation of toner particles found without problem upon using as liquid developer
D: Floatage and precipitation due to aggregation of toner particles clearly found
E: Floatage and precipitation due to aggregation of toner particles considerably found

### (2-2) Environmental Stability of Liquid Developer (Long-Term Stability)

The liquid developers obtained in Examples and Comparative Examples were allowed to stand under an environment at a temperature of 35° C. and a relative humidity of 65% for 6 months. Thereafter, the state of the liquid developer was observed, and changes in viscosity, color, acid value and electric resistance before and after allowing to stand were evaluated based on the following five grades. The acid value was measured according to JIS K2501. The change in color of the liquid developer was evaluated visually. The viscosity was measured with a vibration viscometer according to JIS Z8809. The electric resistance was measured with Universal Electrometer MMA II-17B with an electrode for liquid LP-05 and a shield box P-618 (produced by Kawaguchi Electric Works, Co., Ltd.).
A: Completely no change in viscosity, color, acid value and electric resistance found
B: Substantially no change in viscosity, color, acid value and electric resistance found
C: Slight change in viscosity, color, acid value and electric resistance found without problem upon using as liquid developer
D: Change in viscosity, color, acid value and electric resistance clearly found
E: Change in viscosity, color, acid value and electric resistance considerably found

### (2-3) Fixing Strength

Monochrome images having a prescribed pattern were formed on recording paper (high quality paper, LPCPPA4, produced by Seiko Epson Corp.) with the liquid developers obtained in Examples and Comparative Examples using an image forming apparatus shown in FIGS. 1 to 4. The images were then heat fixed with the temperature of the heat fixing roller set to 110° C. at a fixing rate of 50 sheets per minute.

Thereafter, the non-offset area was confirmed, and then the fixed image on the recording paper was rubbed with a rubber eraser (sand eraser, LION 261-11, produced by Lion Office Products Corp.) twice with a pressing load of 1.0 kgf. The remaining rate of the image density was measured with X-Rite Model 404, produced by X-Rite, Inc., and evaluated based on the following five grades.
Excellent (A): image density remaining rate of 95% or more
Good (B): image density remaining rate of 90% or more and less than 95%
Allowable (C): image density remaining rate of 80% or more and less than 90%
Slightly poor (D): image density remaining rate of 70% or more and less than 80%
Poor (E): image density remaining rate of less than 70%

### (2-4) Low Temperature Fixing Property

The toners obtained in Examples and Comparative Examples were evaluated for favorably fixable range and low temperature fixing property.

An image forming apparatus having the same constitution as shown in FIGS. 1 to 3 except that the apparatus had no fixing device was prepared. Image samples having an unfixed monochrome toner image formed on a recording medium (high quality paper, LPCPPA4, produced by Seiko Epson Corp.) were prepared by using the image forming apparatus. The solid image on the samples had an attached amount of the toner set to 0.5 mg/cm².

The surface temperature of the fixing roller of the fixing device constituting the image forming apparatus was set to a prescribed temperature, and the recording medium having the unfixed toner image formed thereon was inserted into the fixing device shown in FIG. 4, whereby the toner image was fixed to the recording medium. The occurrence of offset after fixing was then confirmed visually. In the fixing device, the fixing rate was 50 sheets per minute (number of sheets of A4 size paper passing through the nip part). The temperature of the surface of the fixing roller was changed sequentially within a range of from 60 to 160° C., and the occurrence of offset at the temperatures was confirmed. The maximum temperature where low temperature offset occurred was designated as a low temperature offset occurring temperature, which was evaluated based on the following four grades.
Excellent (A): low temperature offset occurring temperature of less than 95° C.
Good (B): low temperature offset occurring temperature of 95° C. or more and less than 110° C.
Slightly poor (C): low temperature offset occurring temperature of 110° C. or more and less than 120° C.
Poor (D): low temperature offset occurring temperature of 120° C. or more

The results obtained are shown in Table 2. In the column of “Low temperature fixing property”, specific values of the low temperature offset occurring temperature (° C.) are shown in parentheses.

TABLE 2

| | Toner particles | | | | | |
|---|---|---|---|---|---|---|
| | | Amount of | | | | Low |
| | Average | particles | | | | temperature |
| | particle | exceeding 5 μm | Storage | Environmental | Fixing | fixing |
| | diameter (μm) | (% by volume) | stability | stability | strength | property |
| Example 1 | 1.9 | <1.0 | A | A | A | B (100° C.) |
| Example 2 | 2.1 | <1.0 | A | A | A | A (90° C.) |
| Example 3 | 2.2 | <1.0 | A | A | A | B (95° C.) |
| Example 4 | 2.4 | <1.0 | A | A | A | A (90° C.) |
| Example 5 | 2.2 | <1.0 | A | A | A | A (90° C.) |
| Example 6 | 2.5 | <1.0 | A | B | A | C (110° C.) |
| Example 7 | 2.7 | 1.5 | A | A | A | B (103° C.) |
| Example 8 | 1.9 | 6.0 | B | B | A | B (100° C.) |
| Comparative | 3.8 | 10.0 | E | D | C | D (120° C.) |
| Example 1 | | | | | | |
| Comparative | — | — | E | E | E | D (120° C.) |
| Example 2 | | | | | | |
| Comparative | — | — | E | E | E | D (120° C.) |
| Example 3 | | | | | | |
| Comparative | 2.7 | 1.5 | E | D | B | B (103° C.) |
| Example 4 | | | | | | |

It was found from Table 2 that the liquid developers of Examples were excellent in storage stability and long-term stability and were also excellent in fixing strength and low temperature fixing property. On the other hand, no sufficient result was obtained with the liquid developers of Comparative Examples.

The toner particles were separated from the liquid developers of Examples and were observed with an electron microscope. The toner particles of Examples 1 to 8 had a non-spherical structure having protrusions on the surface thereof.

Production and evaluation of liquid developers were carried out in the same manner as above except that Pigment Red 122, Pigment Yellow 180 and carbon black (Printex L, produced by Degussa AG) were used as the colorant instead of the cyan pigment, and thus the similar results as above were obtained.

The entire disclosure of Japanese Patent Application No. 2007-146282, filed May 31, 2007 is expressly incorporated by reference herein.

What is claimed is:

1. A liquid developer comprising:
toner particles containing mainly a resin material, and
a nonvolatile insulating liquid,
the toner particles containing therein a liquid constituting the insulating liquid.

2. The liquid developer as claimed in claim 1, wherein the toner particles and the insulating liquid contain a fatty acid triglyceride.

3. The liquid developer as claimed in claim 1, wherein the toner particles and the insulating liquid contain an ester liquid having an aniline point of 30° C. or less.

4. The liquid developer as claimed in claim 1, wherein the toner particles and the insulating liquid contain a fatty acid monoester.

5. The liquid developer as claimed in claim 2, wherein the resin material has an ester and/or a carboxylic acid as a functional group.

6. The liquid developer as claimed in claim 1, wherein the resin material has a crystalline structure and/or a crosslinked structure.

7. A process for producing a liquid developer, the method contains steps of:
preparing a swollen resin liquid containing a resin material swollen with an insulating liquid, by heating a composition containing the resin material and the insulating liquid; and
depositing the resin to form resin fine particles containing mainly the resin material and containing therein the insulating liquid, by cooling the swollen resin liquid.

8. The process for producing a liquid developer as claimed in claim 7, wherein the swollen resin liquid is prepared by heating the composition at a temperature higher than a melting point of the resin material contained in the composition.

9. An image forming apparatus comprising:
plural developing units that provide plural monochrome images having different colors by using plural liquid developers having the different colors;
an intermediate transferring unit that forms an intermediate transferred image containing the plural monochrome images formed in the developing units, the plural monochrome images being sequentially transferred and overlapped to form the intermediate transferred image;
a secondary transferring unit that transfers the intermediate transferred image to a recording medium to form an unfixed color image on the recording medium; and
a fixing unit that fixes the unfixed color image to the recording medium,
the liquid developers each containing toner particles containing mainly a resin material, and an insulating liquid, and
the toner particles containing therein a liquid constituting the insulating liquid.
